(19) United States
(12) Patent Application Publication
(10) Pub. No.: US 2026/0175782 A1
(43) Pub. Date: Jun. 25, 2026

(54) CONVERTIBLE STORAGE BOX ASSEMBLY FOR A VEHICLE

(71) Applicant: Ford Global Technologies, LLC, Dearborn, MI (US)

(72) Inventors: Daniel Rangel Andrade, Mexico City (MX); Andres Abraham Torres Galvez, Mineral de la Reforma (MX); Oliver Boyas Salazar, Jiutepec (MX); Enrique Berlanga Zuñiga, Mexico City (MX); Rosa Elia Vazquez Valdez, Mexico City (MX)

(73) Assignee: Ford Global Technologies, LLC, Dearborn, MI (US)

(21) Appl. No.: 18/987,023

(22) Filed: Dec. 19, 2024

(51) Int. Cl. B60R 7/04

(52) U.S. Cl. CPC B60R 7/04

(57) ABSTRACT

A convertible storage box assembly for a vehicle includes a base having a top side, a pocket generally extending along a circumference of a portion of the top side of the base and a flexible box configured to be stowed within the pocket in a stowed position. The convertible storage box assembly is deployable to an extended position extending upward from the pocket to define a box on the top side of the base for holding one or more cargo items.

### FIELD OF THE DISCLOSURE

The present disclosure generally relates to storage assemblies for motor vehicles, and more particularly relates to a motor vehicle storage box assembly that is convertible between stowed and use positions.

### BACKGROUND OF THE DISCLOSURE

Motor vehicles are commonly equipped with one or more storage compartments such as consoles which may include a storage compartment and a lid configurable to close the storage compartment. For example, a center console typically is installed in some vehicles between a driver and front passenger seat in a front row of seating of the vehicle. It would be desirable to provide for a stowable storage compartment that offers flexible storage capability in the vehicle, particularly in the console area.

### SUMMARY OF THE DISCLOSURE

According to a first aspect of the present disclosure, a convertible storage box assembly for a vehicle includes a base having a top side, a pocket generally extending along a circumference of a portion of the top side of the base and a flexible box configured to be stowed within the pocket in a stowed position. The convertible storage box assembly is deployable to an extended position extending upward from the pocket to define a box on the top side of the base for holding one or more cargo items.

Embodiments of the first aspect of the present disclosure can include any one or a combination of the following features:
the flexible box comprises a silicone box;
the silicone box comprises foldable portions that fold into the stowed position;
a handle provided on an upper portion of the flexible box;
the box is generally configured in a rectangular shape, and wherein the pocket has a generally rectangular shape;
the base is configured to be located in a center console area of the vehicle;
one or more retaining members configured to retain a top portion of the box within the pocket in the stowed position;
the retaining members comprises a plurality of snaps;
the top side of the box defines a step pad; and
the box defines a lid for a console.

According to a second aspect of the present disclosure, a vehicle has a cabin having a floor, a first seat supported on the floor, a second seat supported on the floor and a convertible storage box assembly. The convertible storage box assembly includes a base having a top side, a pocket generally extending along a circumference of a portion of the top side of the base and a flexible box configured to be stowed within the pocket in a stowed position. The convertible storage box assembly is deployable to an extended position extending upward from the pocket to define a box on the top side of the base for holding one or more cargo items.

Embodiments of the second aspect of the present disclosure can include any one or a combination of the following features:
the flexible box comprises a silicone box;
the silicone box comprises foldable portions that fold into the stowed position;
a handle provided on an upper portion of the flexible box;
the box is generally configured in a rectangular shape, and wherein the pocket has a generally rectangular shape;
the base is configured to be located in a center console area between the first and second seats;
one or more retaining members configured to retain a top portion of the box within the pocket in the stowed position;
the retaining members comprises a plurality of snaps;
the top side of the box defines a step pad; and
the box defines a lid in a console.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a forward looking upper perspective view of the front portion of a cabin interior of a motor vehicle having a convertible storage box assembly generally located in the center console area;

FIG. 2 is an upper perspective view of the convertible box assembly having a deployable storage box fully stowed in a peripheral pocket in a base;

FIG. 3 is a cross-sectional view taken through line III-III of FIG. 2 further illustrating the fully stowed box in the pocket;

FIG. 4 is a perspective view of a snap configured to fasten the storage box fixed in place when stowed in the pocket on the base; and

FIG. 5 is an upper perspective view of the convertible box assembly illustrating the storage box in the fully deployed position extending upwards above the base.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

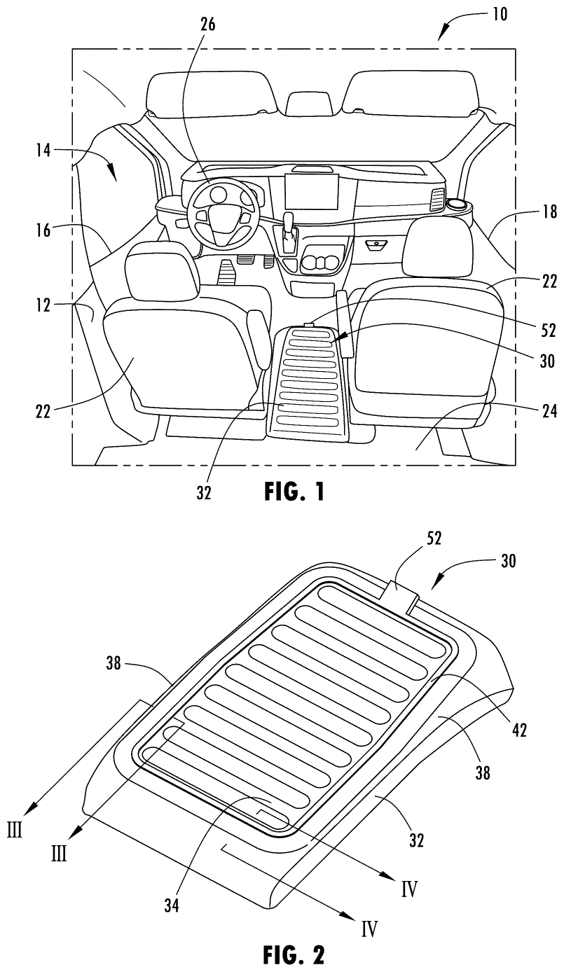

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a convertible storage box assembly for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a cabin interior 14, also referred to as a passenger compartment, of a motor vehicle 10 is generally equipped with a convertible box assembly 30 generally located in a center console area 20 having a convertible storage box shown in a stowed position 32, according to one embodiment. The motor vehicle 10 may be a motor vehicle such as, for example, a wheeled motor vehicle which may be configured as a car, a truck, a van, a bus, an SUV, etc. According to other examples, the motor vehicle 10 may be configured as a train, plane, boat or other form of transportation.

The cabin interior 14 is generally defined by a body 12 which may include body panels, doors such as lateral passenger doors 16 and 18, windows, a floor 24 and a roof. The cabin interior 14 is illustrated equipped with a seating arrangement having one or more seats such as a driver's seat 22A for seating a driver of the motor vehicle 10 and other seats for seating one or more passengers including a front row passenger seat 22B. It should be appreciated that the motor vehicle 10 may include any of a number of seats, including a front row of seating and one or more rear rows of seating. It should further be appreciated that one or more convertible storage box assemblies 30 may be provided on the motor vehicle 10, each convertible storage box assembly 30 having a convertible storage box as shown and described herein. While a convertible storage box assembly 30 is shown located generally in what is commonly referred to as the center console area 20 on a motor vehicle, it should be appreciated that the convertible box assembly 30 may be located in other locations on the motor vehicle 10 such as between other seats in one or more rear rows of seating, in a dashboard generally forward of the front row of seating and other locations supported generally on a supportive structure such as the floor 24, for example.

The cabin interior 14 is further illustrated having a steering wheel 26 generally located forward of the driver's seat 20 and a dashboard 28 that extends laterally along a front portion of the cabin interior 14 forward of the steering wheel 26 between lateral left and right sides of the motor vehicle 10. The convertible storage box assembly 30 is shown, according to one example, located in the center console area 20 that is centrally located in a space that generally separates the left side driver's seat 22A from the right side passenger seat 22B in the front row of seating. The convertible box assembly 30 generally extends between the front row seats 22A and 22B and may extend forward, rearward or towards the dashboard 28, according to various embodiments.

The convertible box assembly 30 includes a base 32 that is supported by an underlying structure shown in one example as the floor 24. According to one embodiment, the base 32 has a top side that provides a step structure configured to enable a passenger to place his or her feet on the top surface such as to enable movement of the passenger between a front row of seating and a rear row of seating or cargo area, such as for a cargo delivery vehicle. Thus, the convertible base assembly 30 is equipped with the base 32 having the top surface 34 that serves as a step structure in this embodiment. In the example shown, the top surface 34 is shown having a frictional surface with corrugated anti-slip tread that is configured to allow a passenger to step on the top surface with enhanced friction. The base 32 may be made of a hard plastic, for example. According to another embodiment, the base 32 may serve as a lid assembled on a console, such as a center console having a storage compartment that may be covered by the lid configured base 32.

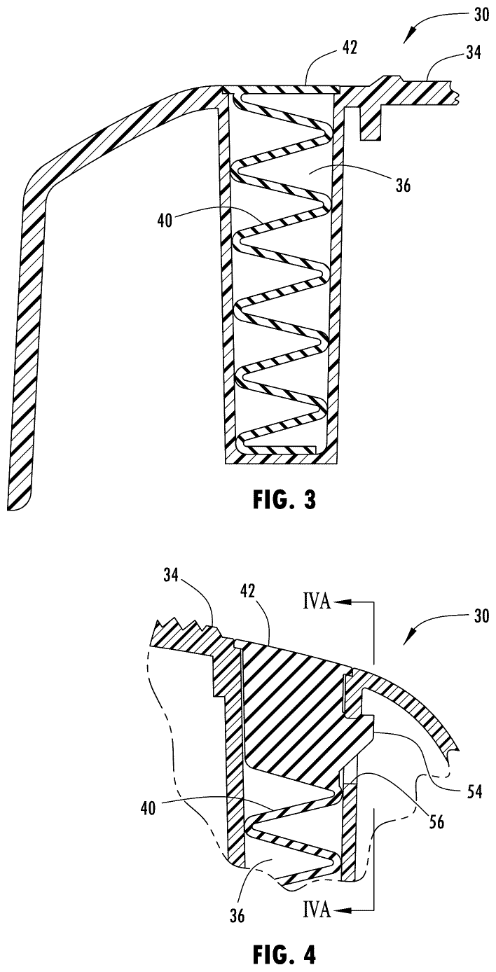

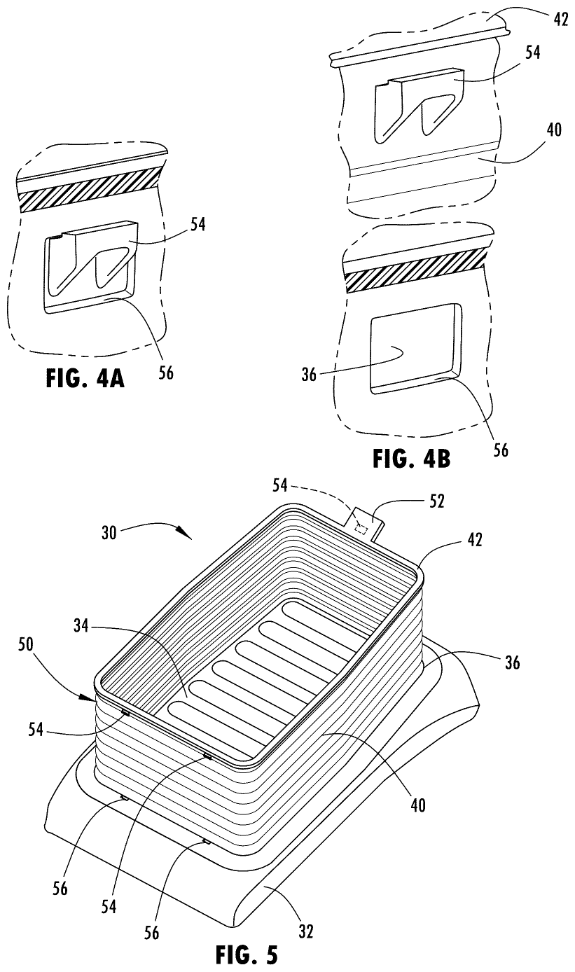

The convertible box assembly 30 is shown further in FIG. 2 with the base 32 having the top surface 34 generally defining a generally rectangular area with rounded corners, according to one example. The top side of the base 32 includes a pocket 36 which extends generally downward into the base 32 along a circumference of a portion of the top side of the base 32 to provide a generally rectangular-shaped recess or trough with rounded corners. The pocket 36 is configured with a shape and size to receive a similar shaped flexible storage box 50 that may be stowed within the pocket 36 and may be deployed to extend upwards from the pocket 36 above the top surface 34 of the base 32 to define a fully deployed storage box as shown in FIG. 5. The flexible storage box 50 has upward extending walls that fold in portions to collapse as shown in FIG. 3 in an accordion-like configuration folded one portion on top of another portion to stow within the peripheral pocket 36 and transitions to unfold with memory to a deployed position having upstanding walls 40 as shown in FIG. 5. The flexible storage box 50 is generally flexible such that it may be stowed within the pocket 36 and yet sufficiently rigid when extended to the fully deployed position to thereby provide upstanding walls in the shape of a basket sufficient to retain one or more cargo items.

The flexible storage box 50 may be configured as a silicone box having silicone side walls, according to one example. The silicone box, may also be referred to as a polysiloxane, which is a polymer composed of siloxane and is also referred to as synthetic rubber. The silicone box is foldable upon portions of its side walls into the stowed position and has sufficient memory to extend and remain in the extended position when deployed. It should be appreciated that the flexible box 50 may otherwise be configured with other flexible material such as a rubber, plastic and more rigid materials which may stow within the pocket 36 and extend upward to be fully deployed as a cargo box.

The flexible storage box 50 is generally shown in one example having a generally rectangular configuration configured to fit within a rectangular-shaped pocket 36 along a circumference of a portion of the top side of the base 32. In one example, the pocket 36 extending along a circumference of the portion of the top side of the base is proximate to a periphery of the top side of the base 32. However, it should be appreciated that the pocket 36 may be formed at any location on the top side of the base 32 and that the pocket 36 and the flexible storage box 50 may have other shapes and sizes, such as a circular shape or an oval shape, for example.

The base 32 further includes a flange 38 that generally extends around the periphery of the base 32. The peripheral flange 38 generally provides an outward and downward extending sidewall for the base 32. The silicone box 50, when stowed within the peripheral pocket 36, may be fixed in the stowed position with one or more retaining members, such as the plurality of snaps 54 shown in FIG. 4. The plurality of snaps 54 may be positioned within the upper portion of the peripheral pocket 36 at various locations so as to retain the top end 42 of the silicone box 50 stowed within the peripheral pocket 36. In the example shown, two snaps 54 are spaced apart at one end and a third snap 54 is provided within a tab 54 at the opposite end. Each snap 54 is configured with a protrusion, such as a tooth, to be retained with a receiver 56 provided within an upper edge of the pocket 36. It should be appreciated that any of a number of plurality of snaps 54 may be employed to retain the silicone box 50 within the peripheral pocket 36. It should further be appreciated that the snaps 54 may be located in any of a number of locations around the pocket 36 to retain the flexible storage box 50 within the pocket 36. The tab 54 has an outward extending handle to enable a user to grasp the tab 54 to pull the box 50 upward to the deployed configuration.

Accordingly, the convertible box assembly 30 advantageously provides for a base 32 that is convertible in that it includes a stowable silicone box 50 that may be stowed within the base 32 and may be deployed upward to provide a deployed box for holding one or more cargo items. As such, the silicone box 50 advantageously provides for enhanced storage on the base 32 of the convertible box assembly 30.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A convertible storage box assembly for a vehicle, the convertible storage box assembly comprising:
a base having a top side;
a pocket generally extending along a circumference of a portion of the top side of the base; and
a flexible box configured to be stowed within the pocket in a stowed position and deployable to an extended position extending upward from the pocket to define a box on the top side of the base for holding one or more cargo items.

2. The convertible storage box assembly of claim 1, wherein the flexible box comprises a silicone box.

3. The convertible storage box assembly of claim 2, wherein the silicone box comprises foldable portions that fold into the stowed position.

4. The convertible storage box assembly of claim 1, further comprising a handle provided on an upper portion of the flexible box.

5. The convertible storage box assembly of claim 1, wherein the box is generally configured in a rectangular shape, and wherein the pocket has a generally rectangular shape.

6. The convertible storage box assembly of claim 1, wherein the base is configured to be located in a center console area of the vehicle.

7. The convertible storage box assembly of claim 1, further comprising one or more retaining members configured to retain a top portion of the box within the pocket in the stowed position.

8. The convertible storage box assembly of claim 7, wherein the retaining members comprises a plurality of snaps.

9. The convertible storage box assembly of claim 1, wherein the top side of the box defines a step pad.

10. The convertible storage box assembly of claim 1, wherein the box defines a lid for a console.

11. A vehicle comprising:
a cabin having a floor;
a first seat supported on the floor;
a second seat supported on the floor; and
a convertible storage box assembly comprising:
a base having a top side;
a pocket generally extending along a circumference of a portion of the top side of the base; and
a flexible box configured to be stowed within the pocket in a stowed position and deployable to an extended position extending upward from the pocket to define a box on the top side of the base for holding one or more cargo items.

12. The vehicle of claim 11, wherein the flexible box comprises a silicone box.

13. The vehicle of claim 12, wherein the silicone box comprises foldable portions that fold into the stowed position.

14. The vehicle of claim 11, further comprising a handle provided on an upper portion of the flexible box.

15. The vehicle of claim 11, wherein the box is generally configured in a rectangular shape, and wherein the pocket has a generally rectangular shape.

16. The vehicle of claim 11, wherein the base is configured to be located in a center console area between the first and second seats.

17. The vehicle of claim 11, further comprising one or more retaining members configured to retain a top portion of the box within the pocket in the stowed position.

18. The vehicle of claim 17, wherein the retaining members comprises a plurality of snaps.

19. The vehicle of claim 11, wherein the top side of the box defines a step pad.

20. The vehicle of claim 11, wherein the box defines a lid in a console.
